(19) United States
(12) Patent Application Publication
(10) Pub. No.: US 2006/0210908 A1
(43) Pub. Date: Sep. 21, 2006

(54) Image forming method, image forming apparatus, and process cartridge

(76) Inventors: Kazuhiko Umemura, Sunto-gun (JP); Yohta Sakon, Isehara-shi (JP); Hiroaki Takahashi, Atsugi-shi (JP); Tomoko Utsumi, Ebina-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/377,244

(22) Filed: Mar. 17, 2006

(30) Foreign Application Priority Data
Mar. 17, 2005 (JP) 2005-077358
Mar. 17, 2005 (JP) 2005-078204

(51) Int. Cl. G03G 21/00

(52) U.S. Cl. 430/125

(57) ABSTRACT

To provide an image forming method including: forming a latent electrostatic image on a photoconductor; developing the latent electrostatic image using a toner to form a visible image; transferring the visible image onto a recording medium; fixing the transferred visible image to the recording medium; and removing toner particles remained on the photoconductor by means of a cleaning blade, wherein the toner comprises an external additive, and the toner has an average circularity of 0.94 or more, and wherein the cleaning blade has a rebound resilience of 60% or more at 23° C., and the contact pressure of the cleaning blade against the photoconductor is 0.2 N/cm or less.

### BACKGROUND OF THE INVENTION

1. Field of the Invention

The present invention relates to an image forming method using an electrographic process that uses a cleaning blade, to an image forming apparatus, and to a process cartridge.

2. Description of the Related Art

In the conventional image forming method using a transfer process, a latent image of a document image is formed on a photoconductor, or a latent image bearing member whose surface is equally charged by means of a charging unit, by exposing it to light according to the document image pattern, and toner is then attached to the latent image using a developing unit to make it visible as a toner image. The toner image is then transferred to transferring paper or intermediate transferring media by means of a transferring unit, and the leftover toner particles on the photoconductor is removed by means of a cleaning unit. In this way the photoconductor is repeatedly used.

For such a cleaning unit, for example, there are various known cleaning units: (1) a cleaning unit equipped with a cleaning blade; (2) a cleaning unit equipped with a fur brush made of conductive or insulating fiber; (3) a cleaning unit equipped with an abrasive cleaning roller; (4) a cleaning unit equipped with a cleaning roller having lubricants; (5) a cleaning unit equipped with a magnetic brush roller which has magnetic powder on its surface; and (6) a cleaning unit equipped with an aspirator.

Among these cleaning units, a cleaning unit using a cleaning blade is most widely used. This kind of a cleaning unit is of simple structure and has excellent toner removal capability.

Any of these cleaning units, however, cannot readily ensure sufficient cleaning ability for removal of toners with an average particle size distribution of 7 μm or less as well as spherical toners—their application to image forming apparatuses have been studied because of their capability of providing excellent image quality.

As a toner production process in which toner diameter is reduced for high image quality, a polymerization process is more robust than a conventional pulverization process in terms of manufacturing costs. Toners with a small particle diameter produced by the polymerization process are roughly spherical in shape and have a sharp particle size distribution, making it possible to provide excellent line and dot reproducibility in digital images.

Since toners with a small particle diameter produced by the polymerization process are spherical and have a small particle diameter compared with those produced by the conventional pulverization process, they have the following drawbacks: they cannot be readily removed from a photoconductor and thus cause cleaning troubles, such as toner escape and generation of black dots. In particular, the use of a cleaning blade increases a likelihood of the occurrence of cleaning troubles in a case where repeated use of the cleaning blade has worn or caused chipping of the cleaning blade edge. In addition, the use of a cleaning blade also increases a likelihood of the occurrence of cleaning troubles in a case where the overuse of the cleaning blade has worn the photoconductor to form microscopic asperities that lead to an increase in the surface roughness thereof.

In order to prevent chipping or wear of the cleaning blade, a technique has been widely used in which a lubricant is applied or supplied to the surface of a cleaning blade. In Japanese Patent Application Laid-Open (JP-A) No. 2002-72713, for example, a predetermined amount of toner is deliberately supplied to a cleaning blade as a lubricant.

However, there is a problem that toners that tend to slip off a cleaning blade often serve as a blade abrasive, not as a lubricant, which, if anything, causes the cleaning blade to wear out rapidly.

Meanwhile, Japanese Patent Application Laid-Open (JP-A) No. 09-50221 attempts to improve the environmental stability of a cleaning blade by specifying its physical characteristics. Such a cleaning blade, however, cannot necessarily provide sufficient cleaning ability and durability when used for spherical toners with small particle diameters.

Japanese Patent Application Laid-Open (JP-A) No. 2003-98925 attempts to secure cleaning ability by using both a photoconductor containing siloxane resin and a cleaning blade with specific physical characteristics. This, however, has a problem of involving reduction in the charging characteristics of the photoconductor due to the presence of siloxane resin, as well as cost increase due to the necessity of coating the photoconductor with a protection layer.

Japanese Patent Application Laid-Open (JP-A) No. 2003-307985 proposes a technique for allowing a cleaning aid to stay around the portion where a cleaning blade and a photoconductor come in contact each other. However, placing a cleaning aid on a desired position is practically impossible; the cleaning aid generally displaces toner and is undesirably scraped off the photoconductor, making it difficult to form an aid layer stably.

In Japanese Patent Application Laid-Open (JP-A) No. 2003-208035 the contact pressure of a cleaning blade against a photoconductor is extremely high, which causes them to wear out rapidly. In addition, there is a problem that it is likely that so-called “filming” occurs because toner is rolled between the photoconductor and the cleaning blade to cause toner components to adhere the photoconductor.

There has been proposed a technique for avoiding the blade turn-over problem associated with reduction of the friction of the cleaning blade edge against a photoconductor; for this, a technique has been proposed in which a thin layer made of vinylidene fluoride resin containing a solid lubricating substance is formed on the tip of the cleaning blade at a position that comes in contact with the photoconductor, with an adhesion layer provided between them (see Japanese Patent Application Laid-Open (JP-A) No. 2000-147972).

There has also been proposed a technique in which a polyurethane resin is impregnated with an isocyanate compound for a predetermined time to create a reaction that forms a partial hardened layer with a low friction coefficient on the cleaning blade edge at a position that comes in contact with the photoconductor, for the purpose of solving the following problems associated with reduction of the friction of the cleaning blade edge against the photoconductor: turn-over of the cleaning blade; toner escape; and toner fusion (see Japanese Patent Application Laid-Open (JP-A) No. 2001-343874).

From a similar point of view, there has also been proposed a technique in which specific values are set for the contact pressure and contact angle of a cleaning blade against a photoconductor and in which the rebound resilience and 300% modulus of the cleaning blade respectively fall in a specific range, whereby a lubricant supply mechanism is provided (see Japanese Patent Application Laid-Open (JP-A) No. 2003-58009).

In order to improve the cleaning ability of a cleaning blade for the removal of spherical toner particles, there has also been proposed a technique in which silica particles of 80 nm to 300 nm in diameter are supplied to the blade edge and retained thereon, and a technique in which a random-shaped or needle-shaped magnetic powder or the like is supplied to the cleaning blade edge and retained thereon by means of a magnetic field to thereby lodge spherical toner particles efficiently (see Japanese Patent Application Laid-Open (JP-A) No. 2002-6710).

Furthermore, in order to achieve reduction in the particle diameter and melting point of toner, there has been disclosed a cleaning blade configured of an edge member made of highly hard rubber and an elastic member that holds the edge member and presses it against a photoconductor (see Japanese Patent Application Laid-Open (JP-A) No. 08-123273).

This technology optimizes the contact pressure of the cleaning blade against the photoconductor and prevents the occurrence of filming—attachment of toner components to the surface of the photoconductor.

As described above, these cleaning methods and techniques concerning a cleaning blade are intended for the optimization of a photoconductor and toner. These cleaning methods and techniques, however, still have problems with respect to cleaning ability, wear of a photoconductor, and the occurrence of filming; therefore, there are problems to be solved before the achievement of reduction in the toner particle diameter, as well as of provision of spherical toners.

### SUMMARY OF THE INVENTION

It is an object of the present invention to provide an image forming method, an image forming apparatus and a process cartridge, which can realize excellent image quality and cleaning ability by facilitating a cleaning operation, especially in a case where spherical and/or small-diameter toner is used; which can prevent the occurrence of blade vibration noise under low temperature conditions, abnormal noise under high temperature conditions, and blade turn-over caused upon operation; and which can provide cleaning stability that cannot be affected by the environment.

Another object of the present invention is to provide an image forming method, an image forming apparatus and a process cartridge, which can provide a cleaning blade with improved chipping resistance and wear resistance as well as can reduce damage and wear of a photoconductor even when the cleaning ability of the cleaning blade has been increased; which can reduce torque required to drive the photoconductor and the like; and which can increase the durability of the apparatus and reduce power consumption.

The image forming method of the present invention comprises: forming a latent electrostatic image on a photoconductor; developing the latent electrostatic image using a toner to form a visible image; transferring the visible image onto a recording medium; fixing the transferred visible image to the recording medium; and removing toner particles remained on the photoconductor by means of a cleaning blade,

wherein the toner comprises an external additive, and the toner has an average circularity of 0.94 or more, and

wherein the cleaning blade has a rebound resilience of 60% or more at 23° C., and the contact pressure of the cleaning blade against the photoconductor is 0.2 N/cm or less.

The image forming apparatus of the present invention comprises: a photoconductor; a latent electrostatic image forming unit configured to form a latent electrostatic image on the photoconductor; a developing unit configured to develop the latent electrostatic image using a toner to form a visible image; a transferring unit configured to transfer the visible image onto a recording medium; a fixing unit configured to fix the transferred visible image to the recording medium; and a cleaning unit configured to remove toner particles remained on the photoconductor by means of a cleaning blade,

wherein the toner comprises an external additive, the external additive comprises particles of 10 nm to 20 nm in diameter plus particles of 200 nm to 300 nm in diameter, primary particles of the external additive have a number-average particle diameter of 20 nm to 100 nm, and the toner has an average circularity of 0.94 or more, and

wherein the cleaning blade has a rebound resilience of 60% or more at 23° C., and the contact pressure of the cleaning blade against the photoconductor is 0.2 N/cm or less.

The process cartridge of the present invention comprises: a photoconductor; a developing unit configured to develop a latent electrostatic image formed on the photoconductor using a toner to form a visible image; and a cleaning unit configured to remove toner particles remained on the photoconductor by means of a cleaning blade,

wherein the toner comprises an external additive, and the toner has an average circularity of 0.94 or more, and

wherein the cleaning blade has a rebound resilience of 60% or more at 23° C., and the contact pressure of the cleaning blade against the photoconductor is 0.2 N/cm or less.

### BRIEF DESCRIPTION OF THE DRAWINGS

FIG. 1 is a schematic cross section of a laminate-type electrographic photoconductor used in the present invention.

FIG. 2 is a schematic cross section of another laminate-type electrographic photoconductor used in the present invention.

FIG. 3 is a schematic view of a cleaning blade of the present invention that is in contact with a photoconductor.

FIG. 4 is a schematic diagram showing an image forming method and image forming apparatus of the present invention.

FIG. 5 is a schematic view of an example of a process cartridge according to the present invention.

### DESCRIPTION OF THE PREFERRED EMBODIMENTS

(Image Forming Method and Image Forming Apparatus)

The image forming apparatus of the present invention includes at least a photoconductor, a latent electrostatic image forming unit, a developing unit, a transferring unit and a fixing unit, and further includes additional units such as a charge eliminating unit, a cleaning unit, a recycling unit and a controlling unit, which are optionally selected as needed.

The image forming method of the present invention includes at least a latent electrostatic image forming step, a developing step, a transferring step and a fixing step, and further includes additional steps such as a charge eliminating step, a cleaning step, a recycling step and a controlling step, which are optionally selected as needed.

The image forming method of the present invention can be suitably carried out in the image forming apparatus of the present invention; the latent electrostatic image forming step can be performed by the latent electrostatic image forming unit, the developing step can be performed by the developing unit, the transferring step can be performed by the transferring unit, the fixing step can be performed by the fixing unit, and the additional steps can be performed by the additional units.

—Latent Electrostatic Image Forming Step and Latent Electrostatic Image Forming Unit—

The latent electrostatic image forming step is a step of forming a latent electrostatic image on a photoconductor.

The material, shape, size, structure, and several features of the photoconductor (referred to as a “latent image bearing member” or “electrographic photoconductor” in some cases) are not particularly limited, and any photoconductor can be appropriately selected from known photoconductors. However, a suitable example of the shape thereof is a drum shape, and examples of the material thereof include inorganic photoconductive materials such as amorphous silicon and selenium, and organic photoconductive materials such as polysilane and phthalopolymethine.

In the photoconductor a photosensitive layer may be either a single layer or a multi-layer. Hereinafter, a function-separated, laminate-type photoconductor will be described by way of example.

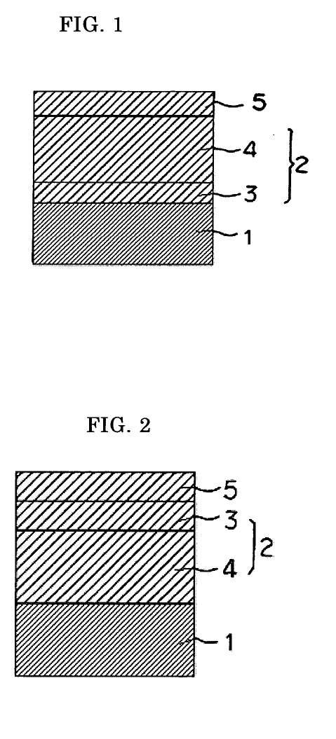

FIG. 1 is a schematic cross section of an example of a laminate-type electrographic photoconductor.

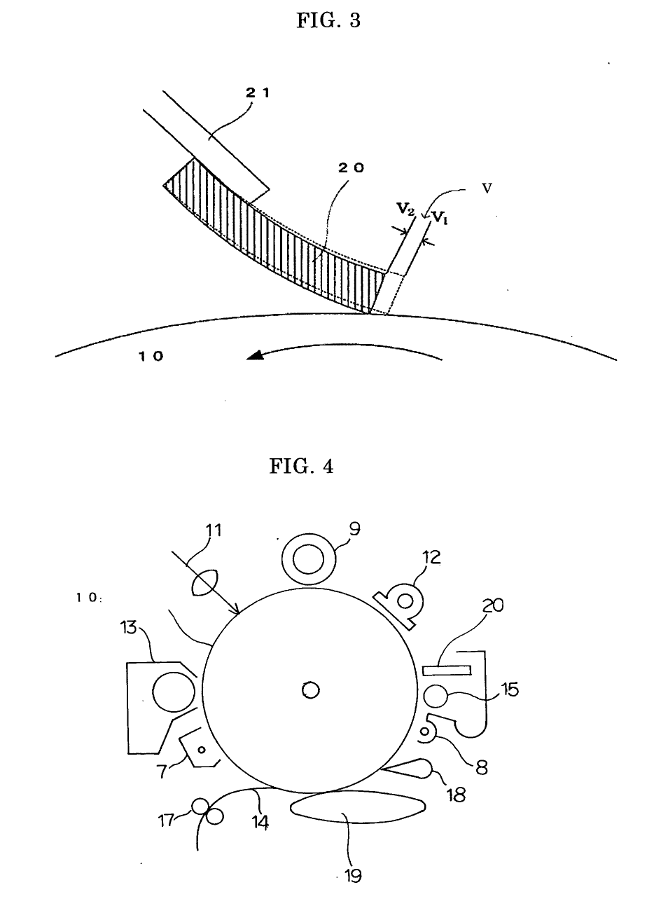

FIG. 2 is a schematic cross section of an example of another laminate-type electrographic photoconductor.

In the photoconductor used in the present invention a photosensitive layer 2 is provided on a conductive support 1 (conductive substrate). The photosensitive layer 2 is a laminate of a charge generation layer 3 composed primarily of charge generation material and a charge transport layer 4 composed primarily of charge transport material.

A protection layer 5 that serves as a surface layer of such an electrographic photoconductor is formed. The protection layer 5 will be described later.

The conductive support 1 is made of material which has a conductivity of 10¹⁰ Ωcm or less in volume resistance; examples of the conductive support 1 include those obtained by covering film-shaped or tubular plastics or paper with a metal such as aluminum, nickel, chrome, nichrome, copper, silver and gold or with a metal oxide such as tin oxide and indium oxide by sputtering or vapor deposition; plates made of, for example, aluminum, aluminum alloys, nickel and stainless steel; and tubes obtained by forming these plates into a tubular shape and subjecting them to surface treatments such as cutting, superfinishing and grinding.

The charge generation layer 3 is a layer composed primarily of charge generation material.

For the charge generation material, organic or inorganic materials can be used; specific examples thereof include monoazo pigments, disazo pigments, trisazo pigments, perylene pigments, perynone pigments, quinacridone pigments, quinon condensed polycyclic compounds, squaric acid dyes, phthalocyanine pigments, napthalocyanine pigments, azulenium salt dyes, selenium, selenium tellurium alloy, selenium-arsenic alloy and amorphous silicon. These charge generation materials may be used singly or in combination.

The charge generation layer 3 is formed by dispersing a predetermined binder resin and the charge generation material in a solvent such as tetrahydrofuran, cyclohexanone, dioxane, 2-butanone or dichloroethane using, for example, a Ball Mill, ATTRITOR or Sand Mill and applying the resultant solution on the conductive support 1.

In this coating step, any of known coating methods can be used: dipping, spray coating, or bead coating.

Examples of a binder resin used for the preparation of coating solution include polyamide resins, polyurethane resins, polyester resins, epoxy resins, polyketone resins, polycarbonate resins, silicone resins, acrylic resins, polyvinyl butyral resins, polyvinyl formal resins, polyvinyl ketone resins, polystyrene resins, polyacrylic resins and polyamide resins.

The content of such a binder resin is preferably 0 part to 2 parts by mass per 100 parts by mass of charge generation material.

The charge generation layer 3 can also be produced by a known vacuum thin film deposition process.

The thickness of the charge generation layer 3 is preferably 0.01 μm to 5 μm, more preferably 0.1 μm to 2 μm.

The charge transport layer 4 can be formed by dissolving or dispersing a charge transport material and binder resin in a predetermined solvent, applying the resultant coating solution onto the layer previously formed, and drying the coating solution. A plasticizer and/or leveling agent may be added to the coating solution as needed.

Low-molecular weight charge transport materials among the charge transport materials can be classified into two groups: electron transport materials, and hole transport materials.

Examples of the electron transport materials include electron-receiving compounds such as chloroanyl, bromanyl, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8,-trinitro-4H-indeno[1,2-b]thiophene-4-on, and 1,3,7-trinitrodibenzothiophene-5,5-dioxide. These electron transport materials may be used singly or in combination.

Examples of the hole transport materials include electron donating-compounds such as oxazole derivatives, oxadiazole derivatives, imidazole derivatives, triphenylamine derivatives, 9-(p-diethylaminostyrylanthracene), 1,1-bis-(4-dibenzylaminophenyl)propane, styrylanthracene, styrylpyrazoline, phenylhydrazones, α-phenylstilbene derivatives, thiazole derivatives, triazole derivatives, phenazine derivatives, acridine derivatives, benzofuran derivatives, benzoimidazole derivatives and thiophene derivatives. These hole transport materials may be used singly or in combination.

When a high-molecular weight electron transport material is used as an electron transport material, a charge transport layer may formed by dissolving or dispersing the high-molecular weight electron transport material in a suitable solvent, applying the resulting coating solution onto the layer previously formed, and drying the coating solution.

Any of the low-molecular weight electron transport materials bearing charge transport substituents on its main chain or side chains can be used as the high-molecular weight electron transport materials.

Examples of the high-molecular weight charge transport materials include polycarbonates, polyurethanes, polyesters and polyethers. Among these, polycarbonates having a triarylamine structure can be suitably used.

Appropriate amounts of a binder resin, plasticizer, leveling agent, lubricant and the like can also be added to a high-molecular weight charge transport material on an as-needed basis.

Examples of a binder resin applied to the charge transport layer 4 together with the charge transport material include thermosetting resins and thermoplastic resins, such as polystyrene resins, styrene-acrylonitrile copolymers, styrene-butadiene copolymers, styrene-maleic anhydride copolymers, polyester resins, polyvinyl chloride resins, vinyl chloride-vinyl acetate copolymers, polyvinyl acetate resins, polyvinylidene chloride resins, polyarylate resins, phenoxy resins, polycarbonate resins, cellulose acetate resins, ethyl cellulose resins, polyvinylbutyral resins, polyvinyl formal resins, polyvinyl toluene resins, acrylic resins, silicone resins, epoxy resins, melamine resins, urethane resins, phenol resins and alkyd resins.

A plasticizer may be added to the charge transport layer 4 as needed; examples thereof include general plasticizers such as dibutyl phthalate and dioctyl phthalate. The added amount of such a plasticizer in the charge transport layer 4 is preferably 0% by mass to 30% by mass of the binder resin.

A leveling agent may also be added to the charge transport layer 4 as needed; examples thereof include silicone oils such as dimethylsilicone oil and methylphenylsilicone oil; and polymers and oligomers bearing a perfluoroalkyl group on their side chains.

The added amount of such a leveling agent in the charge transport layer 4 is preferably 0% by mass to 1% by mass of the binder resin.

Examples of the solvent include tetrahydrofuran, dioxane, toluene, 2-butanone, monochlorobenzene, dichloroethane and methylene chloride.

The thickness of the charge transport layer 4 is preferably 5 μm to 30 μm, and can be appropriately set depending on photoconductor characteristics desired. However, the charge transport layer 4 is preferably as thin as possible in order to achieve high-definition images—the thickness thereof is preferably 20 μm or less, more preferably 15 μm to 18 μm in view of laser exposure.

Here, a determination of the lower limit of the thickness is made with all the following factors taken into consideration—film uniformity, charging ability, and an electronic field required in a downstream developing step. Whatever the case may be, the charge transport layer 4 is required to have high wear resistance in order to be made thin, and therefore, the provision of a protection layer is of great importance, as demonstrated in the present invention.

The content of the charge transport material in the charge transport layer 4 is preferably 40% by mass or more of the charge transport layer. If the content of the charge transport material is less than 40% by mass, it sometimes results in failure to obtain a sufficient light attenuation time in a high-speed electrographic process, where pulse light exposure is performed to expose a photoconductor to laser light for recording.

The carrier mobility of the charge transport layer in the photoconductor is preferably 3×10⁻⁵ cm²/Vs or more, more preferably 7×10⁻⁵ cm²/Vs or more in the charge transport layer electrical field strength range of 2.5×10⁵ V/cm to 5.5×10⁵ V/cm.

The configuration of the charge transport layer 4 can be appropriately altered so that this carrier mobility range can be obtained under any condition.

The carrier mobility can be determined with the known Time-of-Flight Method.

In the laminate-type electrographic photoconductor used in the present invention, a undercoat layer may be provided between the conductive support 1 and the photosensitive layer 2.

In general the undercoat layer is composed primarily of resin, and such a resin is preferably selected from those that are highly insoluble in general organic solvents. This is because the photosensitive layer 2 is formed on the undercoat layer using a solvent.

Examples of such a resin include water-soluble resins such as polyvinyl alcohol resins, casein, sodium polyacrylate; alcohol-soluble resins such as copolymerized nylon and methoxy methylated nylon; and thermosetting resins with three-dimensional network structures, such as polyurethane resins, melamine resins, alkyd-melamine resins and epoxy resins.

Fine powders obtained from metal oxides such as titanium oxide, silica, alumina, zirconium oxide, tin oxide and indium oxide can also be added to the undercoat layer in order to prevent the occurrence of moire and to lower residual voltage.

This undercoat layer can be formed with a suitable coating method using a suitable solvent, as can the photosensitive layer 2.

Alternatively, a metal oxide layer formed through, for example, a sol-gel method using a silane coupling agent, titanium coupling agent, chrome coupling agent or the like can be advantageously used as a undercoat layer.

Compounds obtained by anodizing Al₂O₃; and organic compounds (e.g., polyparaxylene, or parylene,) and inorganic compounds (e.g., SiO, SnO₂, TiO₂, ITO, and CeO₂), which are produced by the vacuum thin film deposition process, are also advantageous as material for the undercoat layer.

The thickness of the undercoat layer is preferably 0 μm to 5 μm.

In the laminate-type electrographic photoconductor it is preferable to provide as a surface layer a protection layer 5 containing a filler on the photosensitive layer 2 in order to protect the photosensitive layer 2 from damage and to improve its durability.

Examples of materials for the protection layer 5 include ABS resins, ACS resins, olefin-vinyl monomer copolymers, chlorinated polyether resins, allyl resins, phenol resins, polyacetal resins, polyamide resins, polyamideimide resins, polyacrylate resins, polyallylsulfone resins, polybutylene resins, polybutylene terephthalate resins, polycarbonate resins, polyethersulfone resins, polyethyne resins, polyethylene terephthalate resins, polyimide resins, acrylic resins, polymethylpentene resins, polypropylene resins, polyphenyleneoxide resins, polysulfone resins, AS resins, AB resins, BS resins, polyurethane resins, polyvinyl chloride resins, polyvinylidne chloride resins and epoxy resins.

A filler is preferably added to the protection layer 5 in order to increase its wear resistance and to prevent the occurrence of filming. Inorganic fine particles are suitable for such a filler; examples thereof include alumina particles and titanium oxide particles, both of which may be rendered hydrophobic by surface treatments. These surface treatments increase bonding strength between a binder component and fine particles in a layer to thereby further increase wear resistance.

The added amount of a filler in the protection layer 5 is preferably 10% by mass to 40% by mass, more preferably 20% by mass to 30% by mass. If the content of the filler is less than 10% by mass, the amount of wear increases to cause reduction in durability. Whereas if the content of the filler exceeds 40% by mass, the voltage of the portions irradiated with light upon exposure significantly increases, thereby reducing its sensitivity to an extent that cannot be ignored.

The average primary particle diameter of the filler is preferably 0.3 μm to 1.2 μm, more preferably 0.3 μm to 0.7 μm. Too small particle diameter may result in failure to obtain sufficient wear resistance, whereas too large particle diameter may result in diffraction of exposure light.

In addition, a dispersing aid is preferably added to the protection layer 5 in order to improve the dispersibility of a filler.

Dispersing aids that are generally applied to known coatings and the like can be used; examples thereof include modified epoxy resin condensates and low-molecular weight polymers resulted from unsaturated polycarboxyxlic acids, and the added amount of such a dispersing aid is preferably 0.5% by mass to 4% by mass, more preferably 1% by mass to 2% by mass of the amount of the filler added.

The addition of the charge transport material in the protection layer 5 is also advantageous. The charge transport material may be added in amounts similar to those for the charge transport layer. In this way it is made possible to increase exposure characteristics, including reduction in the residual voltage.

When a low-molecular weight charge transport material is used, the added amount of such a charge transport material is preferably 20% by mass to 60% by mass of all the solids excluding a filler, so that exposure characteristics can be increased without impairing mechanical characteristics of the protection layer 5.

Alternatively, when a high-molecular weight charge transport material is used, such a charge transport material itself serves as a binder and thus can be added in large amounts; the added amount of the high-molecular weight charge transport material is preferably 20% by mass to 95% by mass of all the solids excluding a filler.

It is generally known that a film in which low-molecular weight charge transport material is added in a binder resin has less strength as the content of such low-molecular weight charge transport material increases.

Moreover, such a film needs to have excellent bonding strength to the binder when inorganic fine particles are to be added, and capability of retaining such inorganic fine particles to its surface layer is of importance in view of its wear resistance. The use of surface-treated inorganic fine particles generally improves the compatibility of the film with the binder and thereby increases the strength of the film itself.

An antioxidant may be added to the protection layer 5 as needed. A description of antioxidants will be provided later in this specification.

Known coating methods (e.g., spray method) can be adopted for the formation of the protection layer 5. The thickness of the protection layer is preferably 0.5 μm to 10 μm, more preferably 4 μm to 6 μm.

An intermediate layer may be optionally provided between the photosensitive layer 2 and the protection layer 5.

The intermediate layer contains a binder resin as the main component; examples of such a binder resin include polyamide resins, alcohol-soluble nylon, water-soluble polyvinyl butyral resins, polyvinyl butyral resins and polyvinyl alcohol resins.

General coating methods can be adopted for the formation of the intermediate layer, and the thickness thereof is preferably about 0.05 μm to 2 μm.

In the present invention it is preferable that an antioxidant, plasticizer, lubricant, ultraviolet absorber, low-molecular weight charge transport material, and leveling agent be added to each layer in order to improve their environmental stability, and especially to prevent reduction in sensitivity and increase in the residual voltage.

Examples of the antioxidant include phenol compounds, para-phenylenediamines, hydroquinones, organic sulfur compounds and organic phosphorous compounds.

Examples of phenol compounds include 2,6-di-t-butyl-p-cresol, butylated hydroxyanisole, 2,6-di-t-butyl-4-ethylphenol, n-octadecyl-3-(4-hydroxy-3,5-di-t-butylphenol), 2,2-methylene-bis-(4-methyl-6-t-butylphenol), 2,2-methylene-bis-(4-ethyl-6-t-butylphenol), 4,4-thiobis-(3-methyl-6-t-butylphenol), 4,4-butylidenebis-(3-methyl-6-t-butylphenol), 1,1,3-tris-(2-methyl-4-hydroxy-5-t-butylphenyl)butane, 1,3,5-trimetyl-2,4,6-tris(3,5-di-t-butyl-4-hydroxybenzyl)benzene, tetrakis-[methylene-3-(3,5-di-t-butyl-4-hydroxyphenyl)propionate]methane, bis[3,3-bis(4-hydroxy-3-t-butylphenyl)butyric acid]glycol ester and tocopherols.

Examples of para-phenylenediamines include N-phenyl-N-isopropyl-p-phenylenediamine, N,N-di-sec-butyl-p-phenylenediamine, N-phenyl-N-sec-butyl-p-phenylenediamine, N,N-di-isopropyl-p-phenylenediamine, and N,N-dimethyl-N,N-di-t-butyl-p-phenylenediamine.

Examples of hydroquinones include 2,5-di-t-octylhydroquinone, 2,6-didodecylhydroquinone, 2-dodecylhydroquinone, 2-dodecyl-5-chloro-hydroquinone, 2-t-octyl-5-methylhydroquinone and 2-(2-octadecenyl)-5-methylhydroquinone.

Examples of organic sulfur compounds include dilauryl-3,3-thiodipropionate, distearyl-3,3-thiodipropionate and ditetradecyl-3,3-thiodipropionate.

Examples of organic phosphorous include triphenylphosphine, tri(nonylphenyl)phosphine, tri(dinonylphenyl)phosphine, tricresylphosphine and tri(2,4-dibutylphenoxy)phosphine.

Examples of the plasticizer include phosphoric acid ester plasticizers, phthalic acid ester plasticizers, aromatic carboxylic acid ester plasticizers, aliphatic dibasic acid ester plasticizers, aliphatic acid ester derivative plasticizers, oxyacid ester plasticizers, epoxy plasticizers, dihydric alcohol ester plasticizers, chlorine-containing plasticizers, polyester plasticizers, sulfonic acid derivative plasticizers, and citric acid derivative plasticizers.

Examples of phosphoric acid ester plasticizers include triphenyl phosphate, tricresyl phosphate, trioctyl phosphate, octyldiphenyl phoshate, trichloroethyl phosphate, cresyldiphenyl phosphate, tributyl phosphate and tri-2-ethylhexyl phosphate.

Examples of phthalic acid ester plasticizers include dimethyl phthalate, diethyl phthalate, diisobutyl phthalate, dibutyl phthalate, diheptyl phthalate, di-2-ethylhexyl phthalate, diisooctyl phthalate, di-n-octyl phthalate, dinonyl phthalate, diisononyl phthalate, diisodecyl phthalate, diundecyl phthalate, ditridecyl phthalate, dicyclohexyl phthalate, butylbenzyl phthalate, butyllauryl phthalate, methyloleyl phthalate, octyldecyl phthalate, dibutyl phthalate and dioctyl phthalate.

Examples of aromatic carboxylic acid ester plasticizers include trioctyl trimellitate, tri-n-octyl trimellitate and octyl oxybenzoate.

Examples of aliphatic dibasic acid ester plasticizers include dibutyl adipate, di-n-hexyl adipate, di-2-ethylhexyl adipate, di-n-octyl adipate, n-octyl-n-decyl adipate, diisodecyl adipate, dicaprylic adipate, di-2-ethylhexyl azelate, dimethyl sebacate, diethyl sebacate, dibutyl sebacate, di-n-octyl sebacate, di-2-ethylhexyl sebacate, di-2-ethoxyethyl sebacate, dioctyl succinate, diisodecyl succinate, dioctyl tetrahydrophthalate and di-n-octyl tetrahydrophthalate.

Examples of aliphatic acid ester derivative plasticizers include butyl oleate, glycerin monooleic acid ester, methyl acetylricinoleate, pentaerythritol ester, dipentaerythritol hexaester, triacetin and tributyrin.

Examples of oxyacid ester plasticizers include methyl acetylricinoleate, butyl acetylricinoleate, butyl phthalyl butyl glycolate and tributyl acetylcitrate.

Examples of epoxy plasticizers include epoxidized soya bean oil, epoxidized linseed oil, butyl epoxystearate, decyl epoxystearate, octyl epoxystearate, benzyl epoxystearate, dioctyl epoxyhexahydrophthalate and didecyl epoxyhexahydrophthalate.

Examples of dihydric alcohol ester plasticizers include diethylene glycol dibenzoate and triethylene glycol di-2-ethylbutyrate.

Examples of chlorine-containing plasticizers include chlorinated paraffin, chlorinated diphenyl, chlorinated methyl esters of aliphatic acids and methoxychlorinated methyl esters of aliphatic acids.

Examples of polyester plasticizers include polypropylene adipate, polypropylene sebacate, polyesters and acetylated polyesters.

Examples of sulfonic acid derivative plasticizers include p-toluenesulfonamide, o-toluenesulfonamide, p-toluenesulfonethylamide, o-toluenesulfonethylamide, toluenesulfon-N-ethylamide and p-toluenesulfon-N-cyclohexylamide.

Examples of citric acid derivative plasticizers include triethyl citrate, triethyl acetylcitrate, tributyl citrate, tributyl acetylcitrate, tri-2-ethylhexyl acetylcitrate and n-octyldecyl acetylcitrate.

Examples of other plasticizers include terphenyl, partial hydrogenated terphenyl, camphor, 2-nitro diphenyl, dinonyl naphthalene and methyl abietate.

Examples of the ultraviolet absorber include benzophenone ultraviolet absorbers, salicylate ultraviolet absorbers, benzotriazole ultraviolet absorbers, cyanoacrylate ultraviolet absorbers, quencher (metallic complex salt) ultraviolet absorbers and HALS (Hindered Amine Light Stabilizer) ultraviolet absorbers.

Examples of benzophenone ultraviolet absorbers include 2-hydroxybenzophenone, 2,4-dihydroxybenzophenone, 2,2,4-trihydroxybenzophenone, 2,2,4,4-tetrahydroxybenzophenone and 2,2-dihydroxy-4-methoxybenzophenone.

Examples of salicylate ultraviolet absorbers include phenyl salicylate and 2,4-di-t-butylphenyl-3,5-di-t-butyl-4-hydroxybenzoate.

Examples of benzotriazole ultraviolet absorbers include (2-hydroxyphenyl)benzotriazole, (2-hydroxy-5-methylphenyl) benzotriazole and (2-hydroxy-3-t-butyl-5-methylphenyl)-5-chlorobenzotriazole.

Examples of cyanoacrylate ultraviolet absorbers include ethyl-2-cyano-3,3-diphenylacrylate and methyl-2-carbomethoxy-3-(paramethoxy)acrylate.

Examples of quencher (metallic complex salt) ultraviolet absorbers include nickel (2,2-thiobis-(4-t-octyl)phenolate) normal butylamine, nickel dibutyl dithiocarbamate and cobalt dicyclohexyl dithiophophate.

Examples of HALS (Hindered Amine Light Stabilizer) ultraviolet absorbers include bis(2,2,6,6-tetramethyl-4-piperidyl)sebacate, bis(1,2,2,6,6-pentamethyl-4-piperidyl)sebacate, 1-[2-[3-(3,5-di-t-butyl-4-hydroxyphenyl)propionyloxy]ethyl]-4-[3-(3,5-di-t-butyl-4-hydroxyphenyl)propionyloxy]-2,2,6,6-tetramethylpyridine, 8-benzyl-7,7,9,9-tetramethyl-3-octyl-1,3,8-triazaspiro[4,5]undecane-2,4-dione, and 4-benzoyloxy-2,2,6,6-tetramethylpiperidine.

The friction coefficient of the surface of the photoconductor is preferably 0.3 or less, more preferably 0.25 or less. If the friction coefficient exceeds 0.3, it may result in the generation of abnormal noise and/or blade vibration noise because the cleaning blade trails the surface of the photoconductor. If the cleaning blade trails the surface of the photoconductor with more force, the blade may be turned over.

The friction coefficient can be determined in accordance with the method described in Japanese Patent Application Lad-Open (JP-A) No. 2001-201899, paragraph [0047]. That is, a belt-shaped measurement member made of wood-free paper of intermediate thickness, cut along its paper-pressing direction, is first brought in contact with a ¼ circumferential surface of a cylindrical photoconductor. Then, a load of 100 g is applied to one end (lower end) of the measurement member, and a force gauge is connected to the other end. Thereafter, the force gauge is moved at a constant speed, and the scale of the force gauge at the time when the belt has began to move is measured. Using the readout, the friction coefficient of the photoconductor can be calculated from the equation: μs=2/π×ln (F/W) (where μs denotes static friction coefficient, F denotes a readout of the force gauge, and W denotes a load (100 g))

This friction coefficient range can be satisfied through any of the following procedures: (1) provide a resin protection layer with low friction coefficient on the uppermost surface of the photoconductor; (2) disperse fine particles with low friction coefficient (e.g., fluorine-containing resin) over the photoconductor; and (3) apply a lubricant (e.g., metal salts of aliphatic acids) on the surface of the photoconductor. These procedures may be combined.

Suitable examples of the lubricant include various waxes and metal soaps; examples of applicable waxes include synthetic waxes such as olefin waxes and ester waxes, and various natural waxes, and examples of applicable metal soaps include metal salts of aliphatic acids (e.g., stearic acid). An optimal lubricant is preferably selected depending on the conditions under which a cleaning blade is used, with the melting points of waxes, the compatibility with a photoconductor, and the amount of a lubricant to be consumed taken into consideration.

The formation of the latent electrostatic image is achieved by, for example, exposing the photoconductor imagewisely after equally charging the entire surface of the photoconductor. This step is performed by means of the latent electrostatic image forming unit.

The latent electrostatic image forming unit includes at least a charging unit which is configured to equally charge the surface of the photoconductor, and an exposing unit which is configured to imagewisely expose the surface of the photoconductor.

The charging step is achieved by, for example, applying voltage to the surface of the photoconductor by means of the charging unit.

The charging unit is not particularly limited, and can be appropriately selected depending on the intended use; examples thereof include known contact-charging units equipped with a conductive or semiconductive roller, blush, film, or rubber blade; and known non-contact-charging units utilizing corona discharge such as corotron or scorotoron.

An exposure step is achieved by, for example, exposing the surface of the photoconductor imagewisely by means of an exposing unit.

The exposing unit is not particularly limited as long as it is capable of performing image-wise exposure on the surface of the charged photoconductor by means of the charging unit, and may be suitably selected depending on the intended use; examples thereof include various exposing units, such as optical copy units, rod-lens-eye units, optical laser units, and optical liquid crystal shatter units.

Note in the present invention that a backlight system may be employed for exposure, where image-wise exposure is performed from the back side of the photoconductor.

—Developing and Developing Unit—

The developing step is a step of developing a latent electrostatic image using a toner or developer to form a visible image.

The formation of a visible image can be achieved, for example, by developing the latent electrostatic image using the toner or developer. This is performed by means of the developing unit.

The developing unit is not particularly limited as long as it is capable of performing developing by means of the toner or developer, and can be appropriately selected among known developing units, depending on the intended use; a suitable example thereof is a developing unit having at least a developing element, which houses the toner or developer therein and is capable of directly or indirectly applying the toner or developer to the latent electrostatic image.

The developing element may be of dry developing type or wet developing type, and may be designed either for monochrome or multiple-color; suitable examples thereof include those having a stirring unit for stirring the toner or developer to leave it electrically charged by frictional electrification, and a rotatable magnet roller.

In the developing element the toner and a carrier are mixed together and the toner is charged by friction, allowing the rotating magnetic roller to bear the charged toner in such as way that toner particles stand on the surface to form a magnetic blush. Since the magnet roller is disposed adjacent to the photoconductor, some toner particles on the magnetic roller that constitute the magnetic blush are electrically transferred to the surface of the photoconductor. As a result, a latent electrostatic image is developed by means of the toner, leading to the formation a visible image, or a toner image, on the surface of the photoconductor.

The developer contained in the developing element is a developer containing the toner. The developer is either a one-component developer or a double-component developer.

—Toner—

The preferable particle size of an external additive to be added to the toner is such that the number-average particle diameter of the primary particles is 20 nm to 100 nm. Furthermore, such an external additive preferably contains particles of 10 nm to 20 nm in diameter plus particles of 200 nm to 300 nm in diameter. More preferably, the standard deviation (σ) of the number-average particle diameter (R) of the primary particles of the external additive is set such that R/4<σ<R. In addition, SF-1 and SF-2 of the external additive are preferably in a range of 100 to 130 and in a range of 100 to 125, respectively.

The number-average particle diameter of the primary particles of the external additive is preferably 30 nm to 90 nm. The use of an external additive that has such a particle size distribution can provide excellent cleaning ability even when substantially spherical toners are used. It is also possible to provide excellent cleaning ability that makes a cleaning blade stable against environmental changes (e.g., temperature and/or humidity change). These multiple effects of the external additive are considered to be attributed to its broad particle size distribution. The particle images of the external additive can be observed with FE-SEM S2400 (manufactured by Hitachi, Ltd.) to calculate their particle size using Luzex, an image analyzer. For example, SF-1 and SF-2 of the external additive can be determined in the following procedure: 100 toner particle images that have been magnified by a factor of 500 with FE-SEM (S-800) (manufactured by Hitachi, Ltd.) are randomly selected, and their image information is transmitted to, for example, Luzex III (an image analyzer manufactured by NIRECO, Corp.) via an interface for further analysis.

Examples of the external additive include silica, alumina, titanium oxide, barium titanate, magnesium titanate, calcium titanate, strontium titanate, zinc oxide, tin oxide, silica sand, clay, mica, wollastonite, diatomaceous earth, chrome oxide, cerium oxide, colcothar, antimonous oxide, magnesium oxide, zirconium oxide, barium sulfate, barium carbonate, calcium carbonate, silicon carbide and silicon nitride.

The content of the external additive is preferably 0.01% by mass to 5% by mass, more preferably 0.01% by mass to 2.0% by mass of the toner.

The average circularity of the toner is preferably 0.94 or more, more preferably 0.95 to 0.98.

In this average circularity range it is possible to highly efficiently transfer the resultant toner image to transferring media, and the variation in the amount of toner particles crushing into a cleaning blade is small. Thus, it is possible to perform a stable cleaning operation, to provide the cleaning blade with excellent cleaning ability and durability, and to provide visible images that are free of halftone inconsistencies.

The volume-average particle diameter of the toner is preferably 7 μm or less, more preferably 4.5 μm to 6.5 μm. The use of toner satisfying this volume-average particle diameter range can provide resultant images with high definition, e.g., sharp characters. The volume-average particle diameter of the toner can be determined with TA-II (Coulter Counter, manufactured by Coulter Corp.).

The toner used in the present invention can be produced by any known process. Toner production processes can be broadly classified into two categories: pulverization processes, and polymerization processes. A polymerization process is preferably employed in the present invention in view of stable particle size control and image quality. One or more kinds of inorganic fine particles and/or organic fine particles may be added to the toner of the present invention as an external additive. The addition of such an external additive permits adjustment of toner flowability and charging characteristics.

Thermosetting resins and thermoplastic resins can be employed for the organic fine particles; examples such resins include vinyl resins, polyurethane resins, epoxy resins, polyester resins, polyamide resins, polyimide resins, silicon resins, phenol resins, melamine resins, urea resins, aniline resins, ionomer resins and polycarbonate resins. These resins may be used singly or in combination. Among these resins, vinyl resins, polyurethane resins, epoxy resins and polyester resins are preferably used singly or in combination. This is because an aqueous solution in which small spherical resin particles are dispersed can be readily obtained.

Vinyl resins used as the organic fine particles are polymers or copolymers resulting from polymerization of vinyl monomers; examples of vinyl resins include styrene-(meth)acrylic acid ester resins, styrere-butadiene copolymers, (meth)acrylic acid-acrylic acid ester polymers, styrene-acrylonitrile copolymers, styrene-maleic anhydride copolymers and styrene-(meth)acrylic acid copolymers.

Examples of monomers constituting vinyl resins include styrene derivatives such as styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene and p-n-dodecylstyrene; ethylenically unsaturated monoolefins such as ethylene, propylene, butylene and isobutylene; unsaturated polyenes such as butadiene; vinyl halides such as vinyl chloride, vinylidene chloride, vinyl bromide and vinyl fluoride; vinyl esters such as vinyl acetate, vinyl propionate and vinyl benzoate; α-methylene aliphatic monocarboxylic acid esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearil methacrylate, phenyl methacrylate, dimethylaminoethyl methacrylate and diethylaminoethyl methacrylate; acrylates such as methyl acrylate, ethyl acrylate, n-butyl acrylate, isobutyl acrylate, propyl acrylate, n-octyl acrylate, dodecyl acrylate, 2-ethylhexyl acrylate, stearil acrylate, 2-chloroethyl acrylate and phenyl acrylate; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; vinylnaphthalenes; and (meth)acrylic acid derivatives such as acrylonitrile, methacrylonitrile and acrylamide. These vinyl monomers can be used singly or in combination.

Among these vinyl monomers, styrene monomers and acrylic monomers are preferably used singly or in combination. Examples of vinyl monomers other than those described above include ethylene-ethyl acrylate copolymers, ethylene-vinyl acetate copolymers, styrene-butadiene copolymers and styrene-isoprene copolymers.

Cross-linkable monomers can be used in order to increase effects of the present invention, and those compounds bearing in their molecules two or more double bonds that can undergo polymerization are used as cross-linkable monomers; examples thereof include aromatic divinyl compounds such as divinylbenzene and divinylnaphthalene; carboxylates bearing two double bonds such as ethylene glycol diacrylate, ethylene glycol di(meth)acrylate and 1,3-butanediol di(meth)acrylate; divinyl compounds such as divinylaniline, divinylether, divinylsulfide and divinylsulfone; and compounds bearing three or more vinyl groups. These compounds are used singly or in combination.

The spherical toner applicable to the present invention can be produced in the following manner, for example. A toner solution, obtained by adding at least binder resin material or pre-polymers thereof, a colorant, and a releasing agent in an organic solvent, is dispersed in an aqueous medium to form small droplets therein, followed by removal the organic solvent and aqueous medium from the resultant solution. Alternatively, pre-polymers in the small droplets may undergo crosslinking reaction and/or extension reaction before removal of the organic solvent and aqueous medium.

Preferably, in an organic solvent is dissolved or dispersed at least (1) a combination of a compound having an active hydrogen and a polymer having a site that can react with this compound (this polymer can be replaced by a unit compound capable of producing such a polymer), or a self-polymerizable material having in a molecule both an active hydrogen site and a site that can react with this active hydrogen site, (2) a colorant, and (3) a releasing agent, preferably in the form of a composition. During the reaction between the active hydrogen and the reactive site or after the reaction has been terminated, the organic solvent and aqueous medium are removed, followed by washing and drying steps. The average particularity of the resultant toner particles may be adjusted by changing the intensity of stirring during the above reaction or by stirring the dried toner particles intensely. Various materials can be adopted for the resin material and pre-polymer thereof; polyester resins and pre-polymers thereof can be suitably used.

The production process described above is just one example; spherical toners may be, of course, produced by a process other than this.

—Transferring and Transferring Unit—

The transferring step is a step of transferring a visible image onto a recording medium. A preferred embodiment of transferring involves two steps: a primary transferring in which a visible image is transferred onto an intermediate transferring medium; and a secondary transferring in which the visible image transferred onto the intermediate transferring medium is transferred onto a recording medium. A more preferable embodiment of transferring involves two steps: a primary transferring in which a visible image is transferred onto an intermediate transferring medium to form a complex image thereon by means of toner of two or more colors, or preferably full-color toner; and a secondary transferring in which the complex image is transferred onto a recording medium.

The transferring step is achieved by, for example, charging the visible image on the photoconductor by means of a transfer charging unit. This transferring step is performed by means of the transferring unit. A preferable embodiment of the transferring unit has two units: a transferring unit which is configured to transfer a visible image onto an intermediate transferring medium to form a complex image; and a secondary transferring unit which is configured to transfer the complex image onto a recording medium.

The intermediate transferring medium is not particularly limited, and can be selected from conventional transferring media depending on the intended purpose; examples thereof include transferring belts.

The transferring unit (i.e., the primary and secondary transferring units) preferably includes at least a transferring element which is configured to charge and separate the toner image from the photoconductor and to transfer it onto a recording medium. The number of the transferring unit to be provided may be either 1 or 2 or more.

Examples of the transferring element include corona transferring elements utilizing corona discharge, transferring belts, transferring rollers, pressure-transferring rollers, and adhesion-transferring elements.

Although paper can be cited as a typical example for recording media, recording media is not particularly limited as long as non-fixed images can be transferred thereon, and can be appropriately selected depending on the intended purpose; PET-base films for OHP sheets and the like can also be adopted.

—Fixing and Fixing Unit—

The fixing step is a step of fixing a transferred visible image onto a recording medium by means of a fixing unit. Fixing may be performed every time each toner of different colors is transferred to the recording medium, or after all toners have been transferred to the recording medium to form a toner laminate thereon.

The fixing unit is not particularly limited, and can be appropriately selected depending on the intended use; examples thereof include a heating-pressurizing unit. The heating-pressurizing unit is preferably a combination of a heating roller and a pressurizing roller, or a combination of a heating roller, a pressurizing roller and an endless belt, for example.

The heating treatment performed by means of the heating-pressurizing unit is preferably performed at a temperature of 80° C. to 200° C.

Note in the present invention that a known optical fixing unit may be used in combination with or instead of the fixing step and fixing unit, depending on the intended purpose.

The charge eliminating step is a step of applying a bias to the charged electrographic photoconductor for removal of charges. This is suitably performed by means of the charge eliminating unit.

The charge eliminating unit is not particularly limited as long as it is capable of applying a bias to the charged photoconductor, and can be appropriately selected from conventional charge eliminating units depending on the intended use. A suitable example thereof is a charge eliminating lamp.

The cleaning step is a step of removing toner particles remained on the photoconductor. This is suitably performed by means of the cleaning unit. The cleaning unit is not particularly limited as long as it is capable of removing such toner particles from the photoconductor, and can be suitably selected from conventional cleaners depending on the intended use; a suitable example thereof is a cleaning blade.

The cleaning blade used in the present invention presses against a photoconductor with less force, and therefore, it is possible to reduce the amount of wear of the cleaning blade and to increase its durability. The higher the rebound resilience of the cleaning blade is, the greater the cleaning ability is; the cleaning blade preferably has a rebound resilience of 60% or more, more preferably from 65% to 80%.

The cleaning blade is preferably a counter blade, a blade that contacts a photoconductor, with its photoconductor-contacting end pointing in a direction opposite the direction in which the photoconductor rotates.

The contact pressure of the cleaning blade against the photoconductor is 0.2 N/cm or less, more preferably 0 N/cm to 0.150 N/cm. If the contact pressure is less than 0.2 N/cm, it may result in increased cleaning ability, as well as in the prevention of reduction in the durability due to wear of the photoconductor and the occurrence of abnormal images, such as filming.

FIG. 3 illustrates how a cleaning blade adopted in the present invention contacts a photoconductor.

In this drawing a photoconductor 10 rotates in the direction of arrow, and toner particles remained on the photoconductor 10 are scraped off with a cleaning blade 20, which is held by a cleaning blade holder 21 so as to contact the photoconductor 10 in a counter direction.

Although the optimal conditions under which the cleaning blade 20 contacts the photoconductor 10 vary depending on the elasticity characteristics of the cleaning blade 20, the following parameter values are generally set: the amount of photoconductor indentation=1 mm to 2 mm; the angle formed by the cut surface of the cleaning blade (i.e., cut surface of a polyurethane rubber plate) and the surface of the photoconductor=70° to 85°.

The present invention makes it a condition that V—the difference in the position of an end surface of an elastic cleaning blade between operation (V₁) and non-operation (V₂) of the photoconductor-should be 300 μm or less, more preferably 200 μm or less. This is partly because it has been established that V significantly affects the angle formed by the cut surface of a cleaning blade and the surface of a photoconductor.

If the amount of displacement of the end surface of the cleaning blade is large, the angle formed by the end surface of the cleaning blade and the surface of the photoconductor becomes small, which may make it difficult to perform a cleaning operation with ease. In addition, after a cycle of switching between operation state and non-operation state, the toner particles lodged at the edge region of the cleaning blade become less stable, and thus the likelihood of the occurrence of “toner escape” increases.

The difference in the position of the end surface of the cleaning blade between operation and non-operation of the photoconductor is 300 μm or less, more preferably 100 μm or less, most preferably 20 μm.

The amount of displacement of the end surface of the cleaning blade can be readily determined using, for example, a laser displacement meter; a high-precision laser displacement laser (LC-2400, manufactured by Keyence Corp.) or the like can be used.

The cleaning blade preferably has a rebound resilience of 60% to 75% at 25° C., and the loss tangent (tan δ) peak temperature in the measurement of tensile and viscoelasticity is preferably 5° C. or less, more preferably −50° C. to 5° C.

The protruding amount of the cleaning blade is preferably 6.0 mm or more, more preferably 7.0 mm to 12.0 mm. If the protruding amount is less than 6.0 mm, the adhesiveness between the cleaning blade and the photoconductor is reduced, resulting in reduced cleaning ability.

The cleaning blade preferably has a hardness of 75 degree or less, more preferably 67 degree to 75 degree. High blade hardness may result in the reduction in cleaning ability, and low blade hardness may result in the reduction in the likelihood of the occurrence of filming. Meanwhile, small blade protrusion amount results in reduced cleaning ability, whereas large blade protrusion amount results in the increase in cleaning ability, especially in environmental stability. Large blade thickness results in the reduction in cleaning ability, whereas small blade thickness results in the increase in cleaning ability, especially in environmental stability. If the ratio of blade thickness to blade protruding amount is 1:3 to 1:5, it is possible to provide excellent cleaning ability. If this ratio is below this range (small), cleaning stability is impaired, and it becomes likely that abnormal sounds associated with blade vibration or the like are produced. If this ratio is above this range (large), so-called “blade turn-over” is likely to occur. The hardness of the cleaning blade can be determined in accordance with JIS-K6253.

The cleaning angle, i.e., an angle formed by a surface of the cleaning blade cut along the axial direction of a photoconductor and the surface of the photoconductor at the point where the cleaning blade contacts the photoconductor, is preferably 80° to 85°.

If a cleaning blade has a high rebound resilience and a low contact pressure against a photoconductor, the cleaning blade is provided with excellent cleaning ability to cause the cleaning blade edge to oscillate more quickly, i.e., the frequency of a so-called stick-slip oscillation is increased, and thus the amount of displacement of the cleaning blade edge is reduced, thereby eliminating the variations in the cleaning conditions. Improvement in cleaning ability can be considered to be attributed to the fact that toner particles are flipped as a result of this blade edge oscillation.

Known materials and methods can be adopted for the production of a cleaning blade. Cleaning blades applicable to the present invention can adopt, for example, polyurethane rubber (polyurethane elastomers) which can readily provide high elasticity. Such polyurethane elastomers can be generally prepared by the reaction of polyol components with polyisocyanate components, which is carried out through the following procedure: pre-polymers are first prepared by the reaction of a polyol component (e.g, polyethylene adipate esters or polycaprolactone esters) with a polyisocyanate component (e.g., 4,4-diphenylmethanediisocyanate); a curing agent (and a catalyst on an an-needed basis) is then added to the pre-polymers to advance a crosslinking reaction in a given mold; the resultant pre-polymers are placed in a furnace to advance a post-crosslinking reaction; and the obtained pre-polymers are allowed to stand at room temperature for completeness.

For the polyol component, high-molecular weight polyols may be adopted. Alternatively, two different polyols may be used. Namely, low-molecular weight polyols, and high-molecular weight polyols may be used. Examples of high-molecular weight polyols include polyester polyols—condensation products of alkylene glycols and aliphatic dihydric acids—such as those resulting from condensation between alkylene glycols and adipic acid, such as ethylene adipate ester polyol, butylene adipate ester polyol, hexylene adipate ester polyol, ethylenepropylene adipate ester polyol, ethylenebutylene adipate ester polyol and ethyleneneopenthylene adipate ester polyol; polycaprolactone polyols such as polycaprolactone ester polyols resulting from ring-opening polymerization of caprolactones; and polyether polyols such as poly(oxytetramethylene)glycol and poly(oxypropylene)glycol.

Examples of low-molecular weight polyols include secondary alcohols such as 1,4-butandiol, ethylene glycol, neopentyl glycol, hydroquinone-bis(2-hydroxyethyl)ether, 3,3′-dichloro-4,4′-diaminodiphenylmethane and 4,4′-diaminodiphenylmethane; and tertiary alcohols and polyalcohols such as 1,1,1-trimethylolpropane, glycerin, 1,2,6-hexanetriol, 1,2,4,-butanetriol, trimethylolethane, 1,1,1-tris(hydroxyethoxymethyl)propane, diglycerin and pentaerithritol.

Examples of curing catalysts that can be used for the preparation of polyurethane elastomers include 2-methylimidazole and 1,2-dimethylimidazole; 1,2-dimethylimidazole is suitably used. In general, the added amount of such a curing catalyst is preferably 0.01 part by mass to 0.5 part by mass, more preferably 0.05 part by mass to 0.3 part by mass per 100 parts by mass of main components, i.e., polyol component and polyisocyanate component.

The recycling step is a step of recovering the toner particles removed through the cleaning step to the developing unit. This is suitably performed by means of the recycling unit.

The recycling unit is not particularly limited, and can be appropriately selected from conventional conveyance systems.

Controlling is a step of controlling each of the steps. This is suitably performed by means of the controlling unit.

The controlling unit is not particularly limited as long as the operation of each step can be controlled, and can be appropriately selected depending on the intended use. Examples thereof include equipment such as sequencers and computers.

An image forming apparatus and image forming method according to the present invention will be described with reference to the drawings. FIG. 4 is a schematic view of an example of an image forming apparatus 30.

In this drawing although the photoconductor 10 is a drum-shaped photoconductor, it may be a sheet-shaped or endless belt-shaped photoconductor.

There are provided a pre-transfer charger 7, transfer charger, separation charger, and pre-cleaning charger 8 around the photoconductor 10 on an as-needed basis. Moreover, there are also provided known units, including a corotron, scorotoron, solid-state-charger, and charging roller.

A charging member 9 may be brought in contact with the photoconductor 10, however, placing the charging member 9 close to the photoconductor 10 at a distance of 10 μm to 200 μm by providing a suitable clearance is preferable because it is possible to reduce the amount of wear of them to prevent the occurrence of toner filming at the charging member 9.

In particular, the photoconductor 10 can retain excellent characteristics by providing a clearance of about 50 μm between them. This is because it is possible to minimize any adverse effect on the surface of the protection layer.

The use of a voltage in which a direct current component is superimposed on an alternate current component as a voltage for the charging member 9 is highly effective to stabilize charges and to prevent the occurrence of variations in the level of charges.

However, it has been revealed that although the application of such a voltage can achieve stable charging, the use of this voltage is more likely to wear out the surface layer of a photoconductor during a process than use of a voltage having only a direct-current component. Even when the superimposed voltage is adopted, the photoconductor of the present invention can offer excellent characteristics without entailing problems because of its excellent wear resistance.

Although the transferring unit can adopt any of the charging units (chargers) described above, a transferring unit using a transferring belt 19 shown in FIG. 4 is effectively used.

General light-emitting sources, such as fluorescent lamps, tungsten lamps, halogen lamps, mercury lamps, sodium lamps, light-emitting diodes (LEDs), semiconductor lasers (LDs) and electroluminescence (EL), can be used for the light sources of an image forming part 11, charge eliminating unit 12 and the like.

For a photoconductor to be irradiate with light of a desired wavelength range, various filters can be used, including a sharp cut filter, bandpass filter, near-infrared ray cut filter, dichroic filter, interference filter and color conversion filer.

These light sources are also used, for example, in the transferring step, charge-eliminating step, cleaning step, or exposure step, in addition to the step shown in FIG. 4, all of which involve a light irradiation process. In these steps the photoconductor 10 is irradiated with light.

The toner image developed on the photoconductor 10 by means of a developing unit 13 is transferred onto a transfer sheet 14. At this point, however, some toner particles remain on the photoconductor 10. These toner particles are removed by means of a fur brush 15 and a cleaning blade 20.

This cleaning step is sometimes performed using only a cleaning blade, however, a cleaning brush (e.g., a fur brush) is often used together.

When image exposure is performed after causing an electrographic photoconductor to be positively charged, a positively charged latent electrostatic image is formed on the surface of the electrographic photoconductor.

Developing the latent electrostatic image thus formed using a negatively-charged toner, or charge-detection fine particles, leads to the generation of a positive image, and developing the latent electrostatic image using a positively charged toner leads to the generation of a negative image.

Meanwhile, when image exposure is performed after causing an electrographic photoconductor to be negatively charged, a negatively charged latent electrostatic image is formed on the surface of the electrographic photoconductor.

Developing the latent electrostatic image thus formed using a positively-charged toner, or charge-detection fine particles, leads to the generation of a positive image, and developing the latent electrostatic image using a negatively charged toner leads to the generation of a negative image.

This developing unit adopts known methods, so to does the charge eliminating unit.

Note in this drawing that a reference numeral 17 denotes a resist roller, and a reference numeral 18 a separation claw.

(Process Cartridge)

The process cartridge of the present invention includes at least a photoconductor, a developing unit configured to develop a latent electrostatic image formed on the photoconductor using a toner to form a visible image, and a cleaning unit configured to remove toner particles remained on the photoconductor by means of a cleaning blade, and further includes additional units on an as-needed basis.

The toner contains at least an external additive containing at least particles of 10 nm to 20 nm in diameter plus particles of 200 nm to 300 nm in diameter, wherein the number-average particle diameter of the primary particles of the external additive is 20 nm to 100 nm, the average circularity of the toner is 0.94 or more, the rebound resilience of the cleaning blade at 23° C. is 60% or more, and the contact pressure of the cleaning blade against the photoconductor is 0.20 N/cm or less.

A cleaning blade that is similar to that used for the foregoing image forming apparatus can be used in the process cartridge.

A photoconductor that is similar to that used for the foregoing image forming apparatus can be used in the process cartridge.

A toner that is similar to that used for the foregoing image forming apparatus can be used in the process cartridge.

The process cartridge of the present invention can be detachably attached to various kinds of electrographic apparatuses, facsimiles and printers; it is preferable that the process cartridge of the present invention be attached to the image forming apparatus of the present invention to be described later.

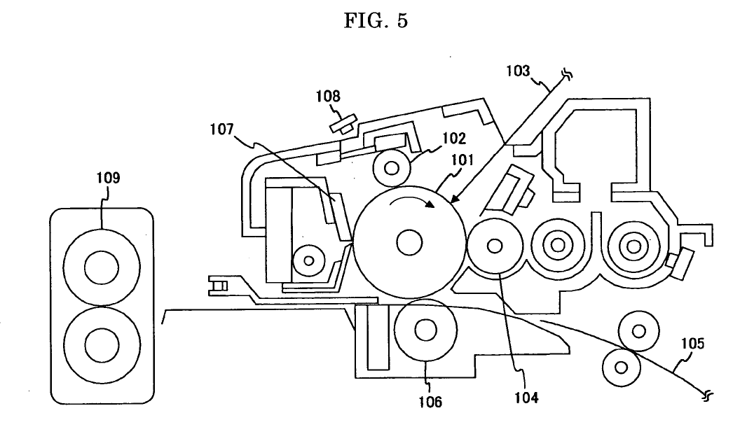

As shown in FIG. 5, the process cartridge of the present invention incorporates a photoconductor 101 and includes, for example, a charging unit 102, developing unit 104, transferring unit 108 and cleaning unit 107. Furthermore, the process cartridge of the present invention includes additional units on an as-needed basis. In FIG. 5 a reference numeral 103 denotes exposure light from an exposure unit using a light source that enables high-definition image writing, and a reference numeral 105 denotes a recoding medium.

A photoconductor that is similar to that used for an image forming apparatus can be used for the photoconductor 101. Any charging material can be used for the charging unit 102.

Hereinafter, an image forming process using the process cartridge shown in FIG. 5 will be described. The photoconductor 101 rotates in the direction of arrow, charged by means of the charging unit 102, and is irradiated with the exposure light 103 from an exposure unit (not shown), whereby a latent electrostatic image corresponding to the exposure image is formed on the surface thereof. This latent electrostatic image is then developed by means of the developing unit 104 using a toner, and the toner image thus formed is transferred onto the recording medium 105 by means of the transferring unit 108. The recording medium 105 is then printed out. Subsequently, the surface of the photoconductor 101 is cleaned by means of the cleaning unit 107, and charges are then eliminated by means of a charge-eliminating unit (not shown). This entire process is repeated.

According to the present invention, it is possible to provide high-quality images by using a cleaning blade with a specific rebound resilience under a specific contact condition and by using a spherical toner, which is achieved by the use of an external additive with a specific particle size, as well as to impart excellent cleaning characteristics. Furthermore, the load against a photoconductor is so small that it is possible to reduce the amount of deterioration (e.g., wear) of both the cleaning blade and photoconductor and to increase their durability.

Hereinafter, the present invention will be described with reference to Examples and Comparative Examples, which however shall not be construed as limiting the scope of the invention thereto.

### EXAMPLES A-1 TO A-8 AND COMPARATIVE EXAMPLES A-1 TO A-5

(Preparation of Cleaning Blade and Toner)

Flat-shaped cleaning blades made of polyurethane were prepared. The characteristics of the cleaning blades are shown in Table 1. Toners of different particle sizes and average circularities were also prepared by the polymerization process, and their characteristics are also shown in Table 1.

The physical properties of the cleaning blade and the particle size and average circularity of the toners were determined with FPIR-100, a flow particle image analyzer.

TABLE 1

| | | | | | | | | Toner | |
|---|---|---|---|---|---|---|---|---|---|
| | Cleaning Blade | | | | | | | Average | |
| | Rebound | Contact | Cleaning | | Protruding | | Tanδ | particle | |
| | resilience | pressure | angle | Hardness | amount | Ratio of thickness | peak | diameter | Average |
| | % | N/cm | ° | degree | mm | to protruding amount | ° C. | μm | circularity |
| Ex. A-1 | 68 | 0.15 | 85 | 66 | 6.5 | 1:4 | −10 | 5.5 | 0.97 |
| Ex. A-2 | 68 | 0.15 | 85 | 70 | 6.5 | 1:4 | −10 | 5.5 | 0.97 |
| Ex. A-3 | 68 | 0.15 | 85 | 70 | 7.3 | 1:4 | −10 | 5.5 | 0.97 |
| Ex. A-4 | 68 | 0.15 | 85 | 70 | 7.3 | 1:4 | −10 | 5.5 | 0.97 |
| Ex. A-5 | 68 | 0.15 | 85 | 70 | 7.3 | 1:4 | −8 | 5.5 | 0.97 |
| Ex. A-6 | 68 | 0.15 | 85 | 70 | 7.3 | 1:4 | −8 | 5.5 | 0.97 |
| Ex. A-7 | 68 | 0.15 | 85 | 70 | 7.3 | 1:4 | −8 | 5.5 | 0.97 |
| Ex. A-8 | 68 | 0.15 | 85 | 70 | 7.3 | 1:4 | −8 | 5.5 | 0.97 |
| Compara. Ex. A-1 | 65 | 0.25 | 85 | 78 | 5 | 1:2.5 | −8 | 5.5 | 0.97 |
| Compara. Ex. A-2 | 50 | 0.25 | 83 | 70 | 7.3 | 1:4 | −2 | 5.5 | 0.97 |
| Compara. Ex. A-3 | 40 | 0.15 | 82 | 70 | 7.3 | 1:4 | 3 | 5.5 | 0.97 |
| Compara. Ex. A-4 | 35 | 0.28 | 70 | 70 | 7.3 | 1:4 | 5 | 5.5 | 0.97 |
| Compara. Ex. A-5 | 65 | 0.25 | 85 | 78 | 5 | 1:2.5 | −8 | 5.5 | 0.97 |

(External Additive)

For the preparation of external additives for toner, 1.5 parts by mass of spherical silica fine particles with a particle size shown in Table 2 were added to 100 parts by mass of toner through a wet process.

The particle size, SF-1 and SF-2 of the external additives, and the friction coefficient of the photoconductor were determined in the following procedure. Specifically, 500 or more particle images were taken with S4200, an electron scanning microscope manufactured by Hitachi, Ltd., and were transferred to Luzex III (an image analyzer manufactured by NIRECO, Corp.) for further analysis.

TABLE 2

| | External additive | | | | | | | |
|---|---|---|---|---|---|---|---|---|
| | Number-average | Particles | Particles | Relationship | | | Photoconductor | |
| | particle diameter | of 10-20 nm | of 200-300 nm | of σ | | | Protection | Friction |
| | (nm) | in diameter | in diameter | with R | SF-1 | SF-2 | layer | coefficient |
| Ex. A-1 | 80 | Contained | Contained | R/4.5 | 115 | 110 | Not provided | 0.4 |
| Ex. A-2 | 80 | Contained | Contained | R/4.5 | 115 | 110 | Not provided | 0.4 |
| Ex. A-3 | 80 | Contained | Contained | R/4.5 | 115 | 110 | Not provided | 0.4 |
| Ex. A-4 | 80 | Contained | Contained | R/4.5 | 115 | 110 | Not provided | 0.4 |
| Ex. A-5 | 80 | Contained | Contained | R/4.5 | 115 | 110 | Not provided | 0.4 |
| Ex. A-6 | 80 | Contained | Contained | R/2 | 110 | 108 | Not provided | 0.4 |
| Ex. A-7 | 80 | Contained | Contained | R/2 | 110 | 108 | Provided | 0.4 |
| Ex. A-8 | 80 | Contained | Contained | R/2 | 110 | 108 | Provided | 0.25 |
| Compara. Ex A-1 | 80 | Contained | Contained | R/2 | 110 | 108 | Provided | 0.25 |
| Compara. Ex A-2 | 80 | Contained | Contained | R/2 | 110 | 108 | Not provided | 0.5 |
| Compara. Ex A-3 | 80 | Contained | Contained | R/2 | 110 | 108 | Not provided | 0.25 |
| Compara. Ex A-4 | 80 | Contained | Contained | R/2 | 110 | 108 | Provided | 0.25 |
| Compara. Ex A-5 | 80 | Not contained | Not contained | R/5 | 108 | 105 | Provided | 0.25 |

(Photoconductor)

Next, a protection layer containing 25% by mass of alumina fine particles (produced by Sumitomo Chemical Co., Ltd. bland name: AA-03, average particle diameter: 0.3 μm,) was deposited onto a photoconductor mounted on a multifunctional system (Imagio Neo C385, manufactured by RICOH Co., Ltd.) in a thickness of 5 μm. In this way a photoconductor was of this Example prepared. The friction coefficient of the photoconductor was controlled by adjusting the supply of a solid lubricant arranged together with a nylon brush that rotates in the vicinity of a photoconductor of the Imagio Neo C385.

The original cleaning blade and photoconductor of the Imagio Neo C385 were removed and replaced with those prepared above, and their cleaning characteristics, the amount of wear of the cleaning blade and photoconductor, and image quality were then evaluated under the conditions shown in Table 3. The results are summarized in Table 3.

—Cleaning Ability—

In each environment the surface of the photoconductor, after formation of 10,000 images, was visually observed to determine the evaluation grades in each case. The greater the amount of remained toner particles on the photoconductor, the lower the evaluation grade.

—Image Quality—

Image quality was evaluated by determining the resolution and gradient of an image in the following procedure.

Resolution: Equi-spaced, parallel lines were reproduced in sheets and were observed for their thickness; each sheet was graded in a scale of 1 to 5, with those with thinner lines being 5 (i.e., excellent) and those with thicker lines 1 (i.e., poor).

Gradient: Circles with 15 different image densities were reproduced in sheets, and the image density in each circle was measured with X-RITE; each sheet was graded in a scale of 1 to 5, with those with a greater number of circles with different image densities being 5 (excellent) and those with a less number of circles with different image densities “1” (poor).

—The Amount of Wear of the Photoconductor—

The amount of wear of the photoconductor was determined in the following procedure. At first, the thickness of the photoconductor was determined by measuring the thickness of points of the photoconductor at intervals of 1 cm along the longitudinal direction thereof by use of FICSHER SCOPE MMS (an eddy-current thickness gauge, manufactured by FISCHER Corp.) and by averaging the measured thickness values. In this way the thickness of the photoconductor was measured after and before the formation of images, and the difference in thickness was set as the amount of wear.

—The Amount of Wear of the Cleaning Blade—

The amount of wear of the cleaning blade was determined by observing it using VHX-100 (manufactured by KEYENCE Corp.) for the measurement of the width of the surface created as a result of wear.

—Filming—

In each environment the surface of the photoconductor, after formation of 10,000 images, was visually observed to determine the occurrence of filming. Filming causes changes in the glaze of the surface of the photoconductor. That is, the greater the occurrence of filming, the lower the evaluation grade.

—Blade Vibration Noise and Abnormal Noise—

The sound level during the operation of an image formation process was measured. The occurrence of blade vibration noise and abnormal noise generates loud sounds.

—Blade Turn-Over—

Whether or not blade turn-over occurred was observed during the operation of an image formation process. The occurrence of blade turn-over causes cleaning troubles and reduces the performance of the image formation apparatus.

TABLE 3

| | | | | | | | | | Blade | |
|---|---|---|---|---|---|---|---|---|---|---|
| | Cleaning ability | | | | | | Amount of | | vibration | |
| | Room | Low | High | | | Amount of | wear of | | and | |
| | temp | temp | temp | Image quality | | wear of | cleaning | | abnormal | Blade |
| | (23° C.) | (10° C.) | (32° C.) | Resolution | Gradient | photoconductor | blade | filming | noise | turn-over |
| | Rank | Rank | Rank | Rank | Rank | μm | μm | Rank | Not occurred | Not occurred |
| Ex. A-1 | 5 | 4 | 4 | 4 | 4 | 1.5 | 22 | 4 | Not occurred | Not occurred |
| Ex. A-2 | 5 | 4 | 4 | 4 | 4 | 1.6 | 20 | 5 | Not occurred | Not occurred |
| Ex. A-3 | 5 | 5 | 4 | 4 | 4 | 1.5 | 23 | 5 | Not occurred | Not occurred |
| Ex. A-4 | 5 | 5 | 5 | 4 | 4 | 1.4 | 20 | 5 | Not occurred | Not occurred |
| Ex. A-5 | 5 | 5 | 5 | 4 | 4 | 1.4 | 18 | 5 | Not occurred | Not occurred |
| Ex. A-6 | 5 | 4 | 5 | 5 | 5 | 1.4 | 18 | 5 | Not occurred | Not occurred |
| Ex. A-7 | 5 | 4 | 5 | 5 | 5 | 0.5 | 10 | 5 | Not occurred | Not occurred |
| Ex. A-8 | 5 | 5 | 5 | 5 | 5 | 0.6 | 11 | 5 | Not occurred | Not occurred |
| Compara. Ex A-1 | 4 | 4 | 4 | 4 | 4 | 1.8 | 23 | 4 | Not occurred | Not occurred |
| Compara. Ex A-2 | 3 | 3 | 3 | 4 | 4 | 2.0 | 32 | 4 | Occurred | Occurred |
| Compara. Ex A-3 | 3 | 2 | 3 | 4 | 4 | 2.2 | 30 | 4 | Not occurred | Not occurred |
| Compara. Ex A-4 | 4 | 2 | 2 | 4 | 4 | 2.0 | 28 | 4 | Not occurred | Not occurred |

According to the present invention, it is made possible to retain excellent cleaning ability and to reduce the likelihood of the occurrence of filming, a phenomenon in which toner or wax adhere a photoconductor, by setting the hardness of a cleaning blade to 72 degree or less. It is also made possible to improve cleaning stability, especially environmental stability, by setting the protruding amount of the cleaning blade to a specific range.

According to the present invention, it is made possible to improve cleaning stability, especially environmental stability, by setting the ratio of thickness to protruding amount of the cleaning blade within a specific range.

According to the present invention, it is made possible to improve environmental stability by setting the loss tan δ peak temperature to 0° C. or less.

According to the present invention, it is made possible to provide excellent cleaning ability by setting the particle size of an external additive to be mixed with toner within a specific range to thereby render toner particles with substantially spherical shape.

According to the present invention, it is made possible to increase wear resistance and durability of the cleaning blade and photoconductor by providing a protection layer on the photoconductor.

According to the present invention, it is made possible to keep excellent cleaning ability, wear resistance and durability and to prevent the occurrence of cleaning troubles—blade vibration noise, abnormal noise and blade turn-over, by setting the friction coefficient of the surface of the photoconductor to 0.3 or less.

According to the present invention, the provision of a process cartridge having a toner, photoconductor, charging unit, and developing unit made its handling and maintenance easy.

### EXAMPLE B-1

A photoconductor in which a protection layer of 5 μm thickness containing 25% by mass of alumina fine particles (produced by Sumitomo Chemical Co., Ltd. bland name: AA-03, average particle diameter: 0.3 μm,) is disposed was attached to a cleaning characteristics-evaluation apparatus.

In this apparatus each unit (e.g., a developing unit and a cleaning unit) is so arranged that an electrographic process can be re-created; in particular, the cleaning unit is so designed that a cleaning blade can press against the photoconductor under various contact conditions.

The evaluation of cleaning ability was made under the following conditions.

The evaluation was made at a temperature of 20° C. and relative humidity of 65%.

A latent electrostatic image was visualized on the photoconductor using toner by applying a developing bias voltage.

The amount of toner used for development was so set that the optical reflection density of an adhesive tape on which all of the toner particles are transferred was 0.2.

The photoconductor was rotated one turn, with the cleaning blade brought in contact with the photoconductor.

The linear speed of the photoconductor was set to 125 mm/s, and the amount of photoconductor indentation was set to 1.2 mm. The cleaning angle, an angle formed by the cut (end) surface of the cleaning blade and the surface of the photoconductor, was set while the rotation of the photoconductor stopped.

The toner particles remained on the surface of the photoconductor after one rotation of the photoconductor were similarly transferred onto an adhesive taper, followed by measurement of the optical reflection density.

—Toners—

Toners were produced by the polymerization process.

Toner Base A: average circularity=0.98, average particle diameter=6.2 μm

Toner Base B: average circularity=0.94, average particle diameter=4.4 μm

External Additive A:

1.5 parts by mass of small diameter-silica particles (H2000, produced by Clariant K. K, number-average particle diameter=10 nm);

0.5 part by mass of small diameter-titanium oxide particles (MT-150AI, produced by Tayca Corporation, number-average particle diameter=15 nm); and

1.0 part by mass of large diameter-silica particles (UFP-30H, produced by Denki Kagaku Kogyo Kabushiki Kaisha, number-average particle diameter=80 nm)

Note that the number-average particle diameter as a whole is 40 nm

External Additive B: 1.5 parts by mass of small diameter-silica particles (H2000, produced by Clariant K. K, number-average particle diameter=10 nm); and

0.5 part by mass of small diameter-titanium oxide particles (MT-150AI, produced by Tayca Corporation, number-average particle diameter=15 nm)

Note that the number-average particle diameter as a whole is 15 nm.

Toner A: Toner Base A plus External Additive A

Toner B: Toner Base A plus External Additive B

Toner C: Toner Base B plus External Additive A

As a urethane rubber blade for evaluation, a urethane rubber blade of 2 mm thickness, whose length from the tip of a blade holder to its edge is 7.3 mm, was prepared.

The elasticity characteristics of the urethane rubber part of the blade were as follows: hardness=70 degree; rebound resilience=68%; and loss tan δ peak temperature=−10° C. Here, Toner A was used.

The contact pressure of the blade against the photoconductor was set to 0.2 N/cm, and the cleaning angle was set to 80°.

After rotating the photoconductor a thousand turns, the blade was evaluated for its cleaning ability under the conditions described above. The optical reflective density—the concentration of the toner particles remained after cleaning—was 0.008, which means that no cleaning trouble occurred.

Note that the amount of displacement of an end surface of the cleaning blade after the activation of the photoconductor was 120 μm.

### EXAMPLE B-2

Evaluation of the cleaning ability of a cleaning blade was made under the same conditions described in Example B-1, with the exception that a urethane rubber part having the following elasticity characteristics was used: hardness=67 degree; rebound resilience=62%; and loss tan δ peak temperature=−15° C.

The amount of displacement of the end surface of the cleaning blade was 150 μm.

The cleaning ability evaluation was made as described above, and the cleaning blade offered excellent cleaning ability, with the concentration of the toner particles remained after cleaning expressed in terms of optical reflection density being 0.01.

In addition, a similar cleaning ability evaluation was made for this cleaning blade under low temperature and low humidity conditions, i.e., at a temperature of 10° C. and relative humidity of 15%. The concentration of the toner particles remained after cleaning expressed in terms of optical reflection density was 0.03, and no cleaning trouble was observed.

### EXAMPLE B-3

Evaluation of the cleaning ability of a cleaning blade was made under the same conditions described in Example B-1, with the exception that Toner C was used in stead of Toner A. The amount of displacement of the end surface of the cleaning blade was 130 μm.

The cleaning ability evaluation was made as described above, and the cleaning blade offered excellent cleaning ability, with the concentration of the toner particles remained after cleaning expressed in terms of optical reflection density being 0.02.

### COMPARATIVE EXAMPLE B-1

Evaluation of the cleaning ability of a cleaning blade was made under the same conditions described in Example B-1, with the exception that Toner B was used instead of Toner A, the contact pressure of the cleaning blade against the photoconductor was set to 0.5 N/cm, and the cleaning angle was set to 70°. The amount of displacement of the end surface of the cleaning blade was 360 μm.

The concentration of the toner particles remained after cleaning expressed in terms of optical reflection density was 0.08, and cleaning troubles occurred. Namely, toner particles were remained on the photoconductor in a stripe pattern, thus resulting in poor cleaning ability.

### COMPARATIVE EXAMPLE B-2

Evaluation of the cleaning ability of a cleaning blade was made under the same conditions described in Example B-1, with the exception that a urethane rubber part having as elasticity characteristics a hardness of 78 degree, rebound resilience of 25% and loss tan δ peak temperature of 5° C. was used.

The amount of displacement of the end surface of the cleaning blade was 350 μm.

The concentration of the toner particles remained after cleaning expressed in terms of optical reflection density was 0.09, and cleaning troubles were also caused. Namely, toner particles were remained on the photoconductor in a band pattern, resulting in poor cleaning ability.

### EXAMPLE B-4

Evaluation of the cleaning ability of a cleaning blade was made under the same conditions described in Example B-1, with the exception that a urethane rubber part having as elasticity characteristics a hardness of 74 degree, rebound resilience of 60% and loss tan δ peak temperature of −5° C. was used, the length of the cleaning blade from the tip of the blade holder to its edge was set to 9.5 mm, and the contact pressure thereof against the photoconductor was set to 0.15 N/cm.

The amount of displacement of the end surface of the cleaning blade was 100 μm.

In this way a cleaning ability evaluation was made, and the cleaning blade offered excellent cleaning ability, with the concentration of the toner particles remained after cleaning expressed in terms of optical reflection density being 0.01.

### EXAMPLE B-5

Evaluation of the cleaning ability of a cleaning blade was made under the same conditions described in Example B-1, with the exception that although a urethane rubber part that is similar to that used in Example B-1 was employed, the length of the cleaning blade from the tip of the blade holder to its edge was set to 9.5 mm, and the cleaning angle was set to 84°.

The amount of displacement of the end surface of the cleaning blade was 90 μm.

The cleaning ability evaluation was made as described above, and no cleaning trouble occurred, with the concentration of the toner particles remained after cleaning expressed in terms of optical reflection density being 0.01.

### COMPARATIVE EXAMPLE B-3

Evaluation of the cleaning ability of a cleaning blade was made under the same conditions described in Example B-1, with the exception that a urethane rubber part having as elasticity characteristics a hardness of 75 degree, rebound resilience of 15% and loss tan δ peak temperature of 12° C. was used and the contact pressure of the cleaning blade against the photoconductor was set to 0.5 N/cm.

The amount of displacement of the end surface of the cleaning blade was 400 μm.

After cleaning of the photoconductor, it was observed that toner particles were not completely removed from the photoconductor to cause a cleaning trouble, where the photoconductor had a band-shaped pattern of toner in its axial direction. The concentration of the toner particles remained after cleaning expressed in terms of average optical reflection density was 0.12.

Subsequently, a similar cleaning ability evaluation was made under low temperature and low humidity conditions i.e., at a temperature of 10° C. and relative humidity of 15%. Cleaning troubles occurred over the entire surface of the photoconductor. For this reason, no measurement was made for the optical reflection density, or the concentration of the toner particles remained after cleaning.

### EXAMPLE B-6

Evaluation of the cleaning ability of a cleaning blade was made under the same conditions described in Example B-2, with the exception that the length of the cleaning blade from the tip of the blade holder to its edge was set to 9.5 mm, the contact pressure thereof against the photoconductor was set to 0.15 N/cm, and the cleaning angle was set to 82°.

The amount of displacement of the end surface of the cleaning blade was 110 μm.

The cleaning ability evaluation was made as described above, and toner particles were almost completely removed from the photoconductor in the axial direction thereof, with the concentration of the toner particles remained after cleaning expressed in terms of optical reflection density being 0.02.

### COMPARATIVE EXAMPLE B-4

Evaluation of the cleaning ability of a cleaning blade was made under the same conditions described in Example B-1, with the exception that a urethane rubber part having as elasticity characteristics a hardness of 78 degree, rebound resilience of 25% and loss tan δ peak temperature of 5° C. was used, the contact pressure of the cleaning blade against the photoconductor was set to 0.5 N/cm, the cleaning angle was set to 70°, and Toner B was used in stead of Toner A.

The amount of displacement of the end surface of the cleaning blade was 410 μm.

In this evaluation several bands of toner patterns were observed on the photoconductor, and the concentration of the toner particles remained after cleaning expressed in terms of average optical reflection density was 0.13, thus resulting in poor cleaning ability.

### EXAMPLE B-7

A cleaning blade with a similar specification to that prepared in Example A-1 was so modified that it could be mounted on a black color station of a color printer (IPSio Color 8000, manufactured by RICOH Co., Ltd.) for a cleaning ability evaluation in an actual machine.

Note that Toner A was used in this Example, as was used in Example B-1.

For charging of the photoconductor, a roller charging system that uses a voltage in which a direct current component is superimposed on an alternate current component was used. This roller charging system was used together with the cleaning blade of the present invention. In this case, abnormal images due to cleaning troubles were not observed on the output sheets after printing of 500 sheets, and there were little toner smudges on the charging roller.

Meanwhile, a cleaning blade with a similar specification to that prepared in Comparative Example B-2 was so modified that it could be mounted on a real machine, and this cleaning blade was similarly evaluated for its cleaning ability. After printing of 500 sheets, multiple numbers of toner bands were observed around the center of the surface of the photoconductor, and the charging roller had some toner smudges as a result of the occurrence of toner escape, the shapes of which corresponding to those of the toner bands.

What is claimed is:

1. An image forming method, comprising:
forming a latent electrostatic image on a photoconductor;
developing the latent electrostatic image using a toner to form a visible image;
transferring the visible image onto a recording medium;
fixing the transferred visible image to the recording medium; and
removing toner particles remained on the photoconductor by means of a cleaning blade,
wherein the toner comprises an external additive, and the toner has an average circularity of 0.94 or more, and
wherein the cleaning blade has a rebound resilience of 60% or more at 23° C., and the contact pressure of the cleaning blade against the photoconductor is 0.2 N/cm or less.

2. The image forming method according to claim 1, wherein the external additive comprises particles of 10 nm to 20 nm in diameter plus particles of 200 nm to 300 nm in diameter, and primary particles of the external additive have a number-average particle diameter of 20 nm to 100 nm,

3. The image forming method according to claim 1, wherein the cleaning blade has a hardness of 75 degree or less.

4. The image forming method according to claim 1, wherein the protruding amount of the cleaning blade is 6.0 mm or more.

5. The image forming method according to claim 1, wherein the ratio of thickness to protruding amount of the cleaning blade is 1:3 to 1:5.

6. The image forming method according to claim 1, wherein the difference in the position of an end surface of the cleaning blade between operation and non-operation of the photoconductor is 300 μm or less.

7. The image forming method according to claim 1, wherein the cleaning blade has a rebound resilience of 60% to 75% at 25° C., and a loss tangent (tan δ) peak temperature in the measurement of tensile and viscoelasticity is 5° C. or less.

8. The image forming method according to claim 1, wherein a cleaning angle, which is an angle formed by a surface of the cleaning blade cut along the axial direction of the photoconductor and a surface of the photoconductor at the point where the cleaning blade contacts the photoconductor, is 80° to 85°.

9. The image forming method according to claim 1, wherein the cleaning blade is a counter blade which contacts the photoconductor with the photoconductor-contacting end thereof pointing in a direction opposite the direction in which the photoconductor rotates.

10. The image forming method according to claim 1, wherein the toner has a volume-average particle diameter of 7 μm or less.

11. The image forming method according to claim 1, wherein the relationship R/4<σ<R is satisfied, where R is the number-average particle diameter of the primary particles of the external additive and σ is the standard deviation of R, and
wherein SF-1 and SF-2 of the external additive are 100 to 130 and 100 to 125, respectively.

12. The image forming method according to claim 1, wherein the photoconductor comprises a protection layer which contains one of alumina particles and titanium oxide particles.

13. The image forming method according to claim 11, wherein the protection layer comprises a charge transport material.

14. The image forming method according to claim 1, wherein the friction coefficient of the surface of the photoconductor is 0.3 or less.

15. An image forming apparatus, comprising:
a photoconductor;
a latent electrostatic image forming unit configured to form a latent electrostatic image on the photoconductor;
a developing unit configured to develop the latent electrostatic image using a toner to form a visible image;
a transferring unit configured to transfer the visible image onto a recording medium;
a fixing unit configured to fix the transferred visible image to the recording medium; and
a cleaning unit configured to remove toner particles remained on the photoconductor by means of a cleaning blade,
wherein the toner comprises an external additive, the external additive comprises particles of 10 nm to 20 nm in diameter plus particles of 200 nm to 300 nm in diameter, primary particles of the external additive have a number-average particle diameter of 20 nm to 100 nm, and the toner has an average circularity of 0.94 or more, and
wherein the cleaning blade has a rebound resilience of 60% or more at 23° C., and the contact pressure of the cleaning blade against the photoconductor is 0.2 N/cm or less.

16. The image forming apparatus according to claim 15, wherein the difference in the position of an end surface of the cleaning blade between operation and non-operation of the photoconductor is 300 μm or less.

17. The image forming apparatus according to claim 15, wherein the latent electrostatic image forming unit comprises a charger which is disposed to come in contact with or come close to the photoconductor.

18. The image forming apparatus according to claim 17, wherein a voltage in which a direct current component is superimposed on an alternate current component is applied to the charger to thereby charge the photoconductor.

19. A process cartridge, comprising:
a photoconductor;
a developing unit configured to develop a latent electrostatic image formed on the photoconductor using a toner to form a visible image; and
a cleaning unit configured to remove toner particles remained on the photoconductor by means of a cleaning blade,
wherein the toner comprises an external additive, and the toner has an average circularity of 0.94 or more, and
wherein the cleaning blade has a rebound resilience of 60% or more at 23° C., and the contact pressure of the cleaning blade against the photoconductor is 0.2 N/cm or less.

20. The process cartridge according to claim 19, wherein the external additive comprises particles of 10 nm to 20 nm in diameter plus particles of 200 nm to 300 nm in diameter, and primary particles of the external additive have a number-average particle diameter of 20 nm to 100 nm

21. The process cartridge according to claim 19, wherein the cleaning blade has a hardness of 75 degree or less.

22. The process cartridge according to claim 19, wherein the protruding amount of the cleaning blade is 6.0 mm or more.

23. The process cartridge according to claim 19, wherein the ratio of thickness to protruding amount of the cleaning blade is 1:3 to 1:5.

24. The process cartridge according to claim 19, wherein the difference in the position of an end surface of the cleaning blade between operation and non-operation of the photoconductor is 300 μm or less.

25. The process cartridge according to claim 19, wherein the cleaning blade has a rebound resilience of 60% to 75% at 25° C., and a loss tangent (tan δ) peak temperature in the measurement of tensile and viscoelasticity is 5° C. or less.

26. The process cartridge according to claim 19, wherein a cleaning angle, which is an angle formed by a surface of the cleaning blade cut along the axial direction of the photoconductor and a surface of the photoconductor at the point where the cleaning blade contacts the photoconductor, is 80° to 85°.

27. The process cartridge according to claim 19, wherein the cleaning blade is a counter blade which contacts the photoconductor with the photoconductor-contacting end thereof pointing in a direction opposite the direction in which the photoconductor rotates.

28. The process cartridge according to claim 19, wherein the toner has a volume-average particle diameter of 7 μm or less.

29. The process cartridge according to claim 19, wherein the relationship R/4<σ<R is satisfied, where R is the number-average particle diameter of the primary particles of the external additive and σ is the standard deviation of R, and
wherein SF-1 and SF-2 of the external additive are 100 to 130 and 100 to 125, respectively.

30. The process cartridge according to claim 19, wherein the photoconductor comprises a protection layer which contains one of alumina particles and titanium oxide particles.

31. The process cartridge according to claim 30, wherein the protection layer comprises a charge transport material.

32. The process cartridge according to claim 19, wherein the friction coefficient of the surface of the photoconductor is 0.3 or less.
